(19) United States
(12) Patent Application Publication
(10) Pub. No.: US 2022/0358617 A1
(43) Pub. Date: Nov. 10, 2022

(54) Depth Encoding at an Edge System to Support Hologram Display

(71) Applicant: Meta Platforms Technologies, LLC, Menlo Park, CA (US)

(72) Inventor: Pranav SAXENA, San Francisco, CA (US)

(21) Appl. No.: 17/869,936

(22) Filed: Jul. 21, 2022

Related U.S. Application Data
(60) Provisional application No. 63/354,378, filed on Jun. 22, 2022.

(51) Int. Cl. G06T 1/20; H04L 67/131; G06T 17/20

(52) U.S. Cl. CPC G06T 1/20; H04L 67/131; G06T 17/20

(57) ABSTRACT

Implementations augment images with depth information to support hologram display. An edge system can receive, from a source system, images of a user. For example, the images can be two-dimensional images captured by multiple cameras at different perspectives (e.g., stereoscopic images), or single perspective images. The edge system can estimate depth information using the images, for example by processing the images using an engine and one or more machine learning models, and generate depth encoded images. The edge system can then transmit the depth encoded images to a target system, which can ultimately display a hologram of the user using the depth encoded images. Accordingly, implementations can offload, from end-user devices (e.g., the source system and/or target system), hologram workloads to an edge system loaded with an engine and machine learning model(s).

### TECHNICAL FIELD

The present disclosure is directed to encoding images with depth information at an edge system to support hologram display.

### BACKGROUND

Holographic displays have grown in popularity with the increased availability of systems and/or devices capable of displaying a hologram. However, holographic calling remains challenging to achieve. In particular, holographic call services include latency requirements in addition to requiring compute power for performing hologram workloads. Other real-time holographic services include similar restrictions, and thus also pose similar challenges. A system that can achieve the latency requirements for real-time communication and meet the compute power requirements of hologram workloads can provide improved holographic services.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a system diagram illustrating components for encoding images with depth information to support hologram display.

FIG. 6 is a system diagram illustrating components of an edge system for encoding images with depth information to support hologram display.

FIG. 7 is a conceptual diagram illustrating an ordered pipeline comprising pre-processing, inference, and post-processing portions.

FIG. 8 is a flow diagram illustrating a process used in some implementations of the present technology for encoding images with depth information to support hologram display.

FIG. 9 is a flow diagram illustrating a process used in some implementations of the present technology for perform pre-processing, inference, and post-processing on received images.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to encoding images with depth information at an edge system to support hologram display. Implementations of an edge system can receive, from a source system, images of a user. For example, the images of the user can be two-dimensional images captured by an artificial reality device. In some cases, the images can be from multiple cameras at different perspectives (e.g., stereoscopic images). Using the images of the user, the edge system can encode depth augmented images, for example by processing the images of the user using an engine and one or more machine learning models. The edge system can then transmit the depth encoded images to a target system, which can ultimately display a hologram of the user using the depth encoded images. Accordingly, implementations can offload, from end-user devices (e.g., the source system and/or target system), hologram workloads to an edge system loaded with an engine and machine learning model(s).

In some implementations, the displayed hologram of the user can be part of a holographic call. For example, images of another user can be received at the edge system from the target system, the edge system can encode the images of the other user with depth information, and the depth encoded images of the other user can be transmitted to the source system, which displays a hologram of the other user. In some implementations, the edge system that encodes the images of the user with depth information can be different from the edge system that encodes the images of the other user with depth information. In these examples, the holographic call between the source systema and the target system can be supported by one or more edge systems configured to augment flat (two-dimensional) images with depth information.

In some implementations, the communications between the edge system(s) and source system/target system are implemented using a real-time communication (RTC) channel. For example, communication between the source system and target system via the edge system can achieve a latency between 100-200 ms over the RTC channel. In another example, latency for communication between the source system and edge system can achieve a latency between 10-50 ms over the RTC channel. In another example, latency for communication between the edge system and target system can achieve a latency between 10-50 ms over the RTC channel.

Implementations of a hologram manager at the edge system(s) can process the two-dimensional images of the user (e.g., captured from one camera or from multiple cameras at different perspectives) to generate depth information. In one example, the hologram manager can synchronize image frames from different perspectives and estimate a depth represented in the synchronized images. In another example, the hologram manager can estimate depth using signal source/perspective image frame(s). Using the estimated depth, the hologram manager can generate a mesh that is a three-dimensional representation of the user. The hologram manager can then encode images with depth information such that the encoded images are representative of the generated mesh. For example, color pixel values (e.g., red, green, blue values) can be augmented with additional depth information that indicates a depth for the color pixel values. The depth encoded images representative of the mesh can support hologram display at the target system.

The hologram manager can generate depth encoded images by performing an ordered pipeline, such as a pre-processing portion, an inference (e.g., machine learning inference) portion, and a post-processing portion. In some implementations, the pre-processing portion can include decoding received images of a user, synchronizing the images of the user (e.g., synchronizing the images from different perspectives), loading a data structure of the synchronized images (e.g., buffering the synchronized images), and other suitable pre-processing. Some images used in implementations are captured from a single source (e.g., are not stereoscopic images), and in these implementations pre-processing can include decoding the images, loading the data structure, and other suitable pre-processing. In some implementations, the inference portion can include processing the images (e.g., via the buffer) using one or more machine learning models to estimate depth information for the images and generate a mesh of the user. In some implementations, the post-processing portion can include encoding depth augmented images, loading the depth augmented images into a data structure (e.g., buffering the depth augmented images), and any other suitable post-processing. For example, a real-time streaming services can stream the depth augmented images from the data structure (e.g., buffer) to a target system.

Implementations of the hologram manager can detect one or more engines at an edge system to configure execution of the ordered pipeline. For example, one or more of the portions of the ordered pipeline can be executed by an engine loaded at an edge system. The ordered pipeline can be executed in sequence for a batch of images, however performance of individual portions of the ordered pipeline can be parallelized for different batches of images depending on the engine(s) loaded at an edge system. Detection of an engine (or runtime) loaded at the edge system that supports parallelization for at least a portion of an ordered pipeline of operations can be achieved by: detection of an engine/runtime identifier associated with multi-core GPU parallelization (e.g., predefined association between the engine identifier and parallelization capabilities); interrogation of the engine (e.g., by one or more scripts) to detect a runtime associated with multi-core GPU parallelization (e.g., CUDA runtime, etc.); any combination of these; or by any other suitable techniques.

In some implementations, when the hologram manager detects a first engine at an edge system, the first engine is used to perform the ordered pipeline in sequence (e.g., for individual batches of images) and parallelize execution at least one portion of the ordered pipeline (e.g., for different batches of images) across multiple cores of one or more graphics processing units (GPUs). In some implementations, when the hologram manager detects a second engine at an edge system, the second engine is used to perform the ordered pipeline in sequence using one or more central processing units (CPUs). In these examples, the first engine can support workload execution in an ordered sequence in combination with multi-core GPU execution of individual components of the workload while the second engine can support workload execution in an ordered sequence in combination with CPU execution of the workloads. Example engines include versions(s) of Spark AR engine, versions(s) of Spark AR Studio, or any other suitable processing engine for visual frames.

In some implementations, parallelized workloads are performed by multiple instances of running engine(s) or runtime environment(s). For example, a configuration file (e.g., manifest) at the edge system can define multiple running instances of engine(s) and/or runtime environment(s). In another example, multiple running instances of engine(s) and/or runtime environment(s) can be detected (e.g., by a script file that interrogates the edge system). One or more workloads can be parallelized across the running engine(s) and/or runtime environment(s) to achieve the parallel execution of workloads.

In some implementations, sequential performance of the ordered pipeline of operations (e.g., for a given batch of images) is achieved by a predefined sequence of services that correspond to the portions of the ordered pipeline. For example, each portion of the ordered pipeline can correspond to a service defined at the edge system (e.g., pre-processing service, inference service, post-processing service). For a given batch of images, running instance(s) of engine(s)/runtime environment(s) can be configured to perform the services corresponding to the ordered pipeline in the defined order. In some implementations, the sequence for the services can be predefined at the edge system or the sequence can be received in a configuration file. For example, a manifest file (or any other suitable configuration file) at the edge system can predefine the sequence for the pre-processing service, inference service, and post-processing service for any image(s) received in association with edge hologram services. In another example, a configuration file can be received in association with the hologram edge service (e.g., from the source system, a third-party system, or any other suitable system). In this example, the configuration file received at the edge system can predefine the sequence for the pre-processing service, inference service, and post-processing service for any image(s) received in association with edge hologram services.

In some implementations, sequential performance of the ordered pipeline of operations is achieved by a blocking mechanism and running engine(s) or runtime environment(s). For example, a manifest file, configuration file, or any other suitable file can configure the scheduling of services at multiple running engine(s) or runtime environment(s) at the edge system. The manifest file or configuration file can define a blocking mechanism that blocks scheduling/execution of later portions of the ordered pipeline (later corresponding services at the edge system) for a given batch of images until execution of earlier portions of the ordered pipeline (earlier corresponding services at the edge system) for the given batch of images.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Conventional hologram services that perform hologram workloads at a source system, target system, and/or in a cloud system suffer from several drawbacks. For example, hologram services that perform the workloads at the source system or target system are limited to end-user systems with compute, battery, and/or memory resources capable of performing such workloads. These conventional systems limit the types of systems/devices that can implement the hologram service. In addition, hologram services that perform workloads on a cloud system suffer from latency drawbacks that limit the capabilities of the service. For example, hologram workloads that are offloaded to a cloud system will fail to achieve a latency for the communications that supports real-time holographic calling.

Implementations offload hologram service workloads to an edge system that supports latency for the communication between a source system and a target system (via the edge system) that meets a latency criteria (e.g., between 100-200 ms). Accordingly, implementations can meet the latency requirements for real-time communications, such as holographic calling. In addition, because the hologram workloads are offloaded to an edge system, a larger variety of end-user systems (e.g., source systems and target systems) can participate in the hologram services, such as end-user systems with limited compute, memory, and/or battery resources.

In some implementations, hologram workloads are parallelized across multiple cores of GPU(s) at the target system. For example, when an engine or runtime that supports parallel execution of workloads is detected at an edge system, the engine/runtime can be used to parallelize hologram workloads across multiple cores of GPU(s). This further increases the speed of performance for the hologram workloads and further reduces the end-to-end latency for communication between the source system and target system via the edge system. In these implementations, compute power at the edge system (e.g., multi-core GPUs) can support hologram services at end-user systems (e.g., the source system and/or target system) that lack this type of compute power.

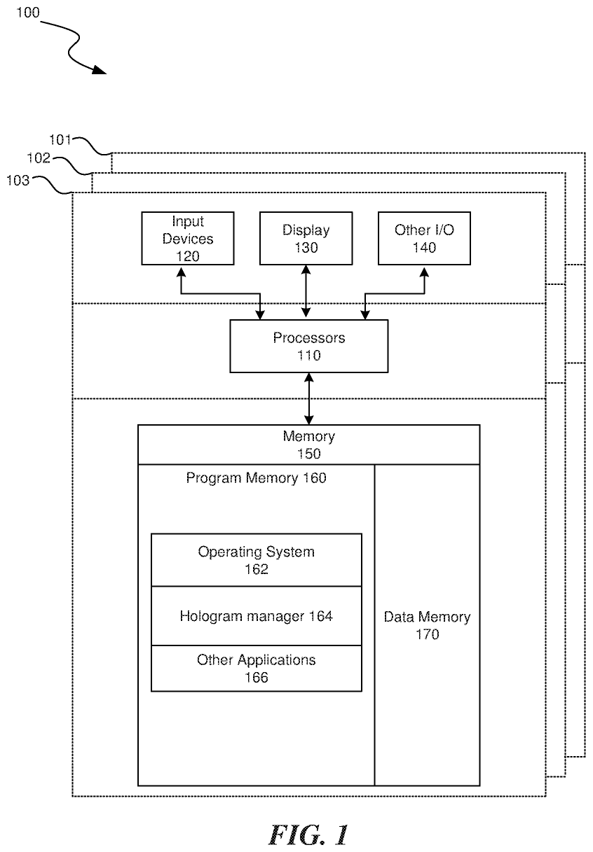

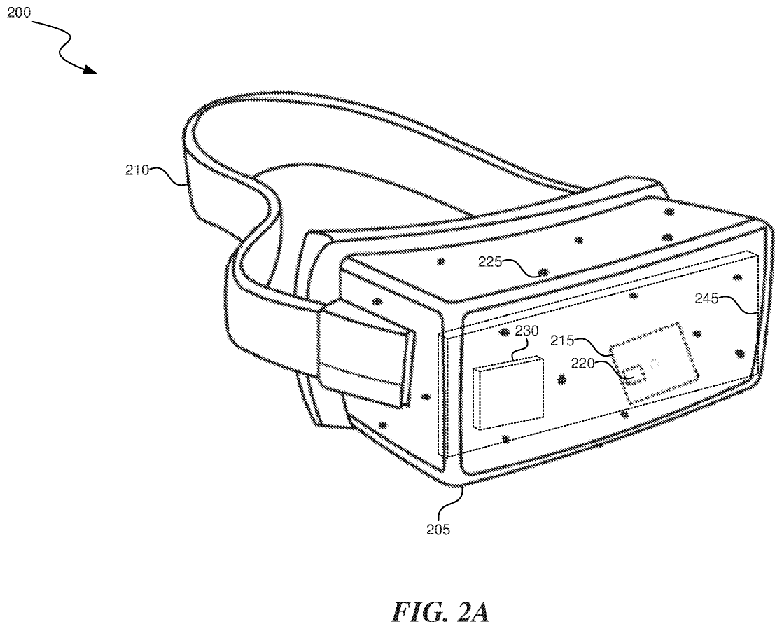

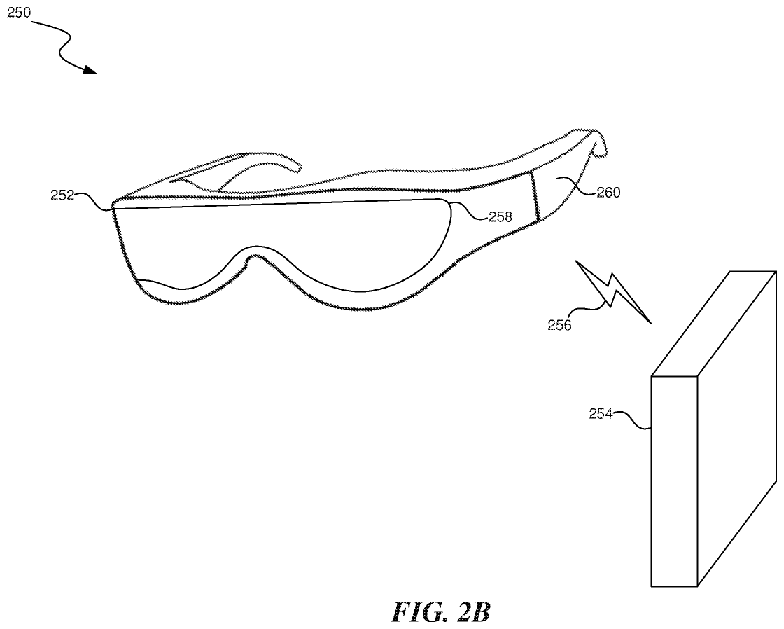

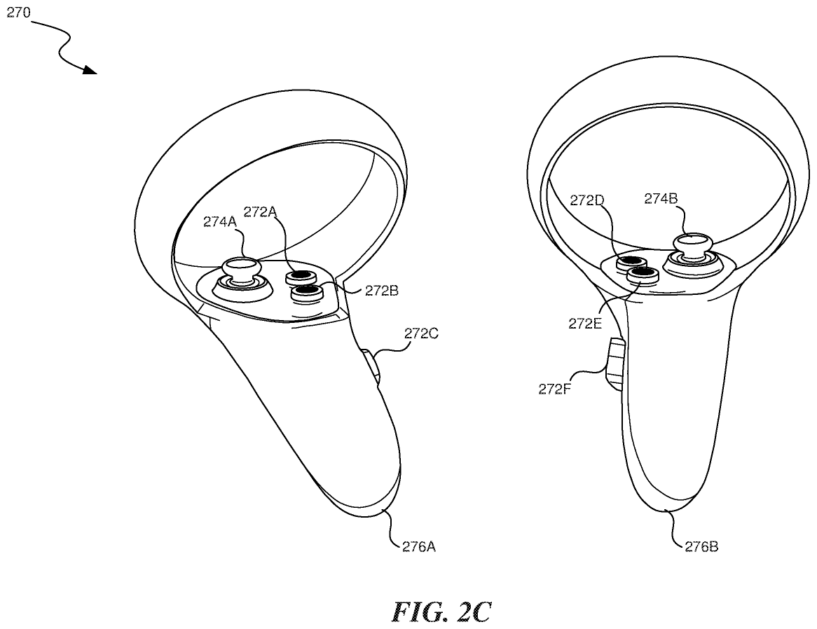

Several implementations are discussed below in more detail in reference to the figures. FIG. 1 is a block diagram illustrating an overview of devices on which some implementations of the disclosed technology can operate. The devices can comprise hardware components of a computing system 100 that augment images with depth information to support hologram display. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, hologram manager 164, and other application programs 166. Memory 150 can also include data memory 170 that can include, e.g., codecs, protocol implementation software, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

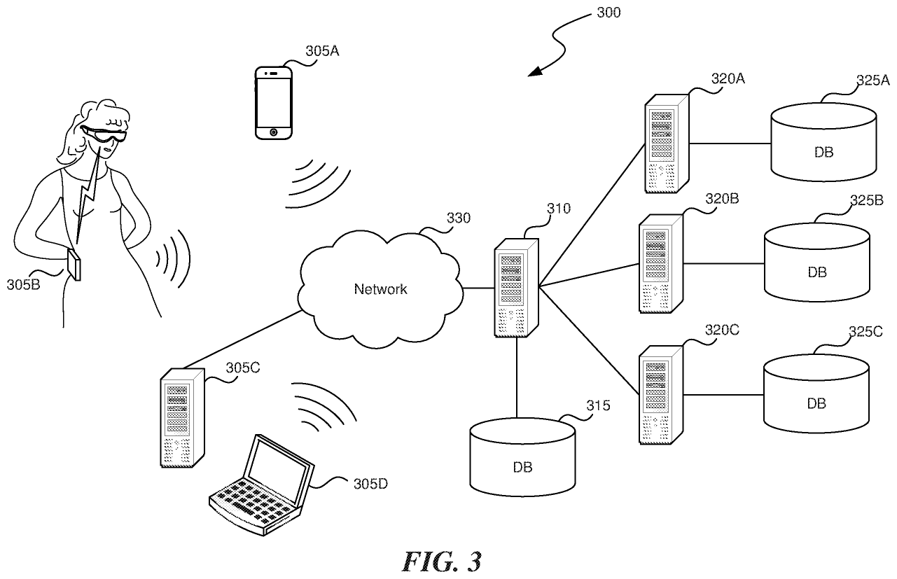

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

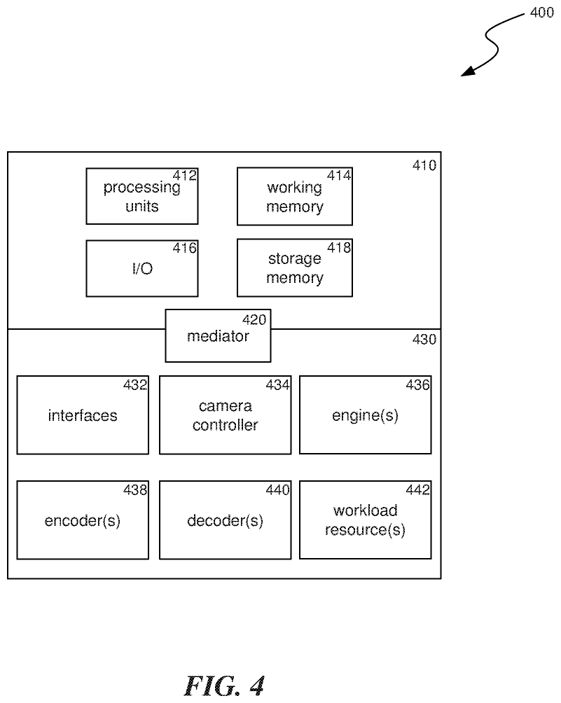

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for encoding images with depth information to support hologram display. Specialized components 430 can include camera controller 434, engine(s) 436, encoder(s) 438, decoder(s) 440, workload resource(s) 442, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

Camera controller 434 can manage one or more cameras that capture images of a user. Camera controller 434 can be located at a source system, in the cloud, on in any other suitable location. For example, the source system can be a client device, such as a laptop, mobile device, XR system, Internet of Things (IoT) device configured with cameras and a display, or any other suitable source system. Camera controller 434 can include software for capturing images of user from multiple cameras (with differing perspectives). In some implementations, camera controller 434 can include information along with the captured frames, such as a timestamp, capture device identifier, or other suitable information. Camera controller 434 can provide the captured frames to one or more encoder(s) 438, such as an encoder at the source system.

Engine(s) 436 can be any suitable engine for processing image data. For example, engine(s) 436 can perform machine learning workload(s) on image data, estimate depth information from images (e.g., stereoscopic images, single source images, etc.), render holograms using depth encoded images, or perform other suitable image processing. Engine(s) 436 can be located at a source system, edge system, and/or target system. In some implementations, engine(s) 436 includes one or more runtime environments, such as a Compute Unified Device Architecture (CUDA) runtime, TensorFlow runtime, TensorRT runtime, and other suitable runtime environments. Some example runtimes at engine(s) 436 can parallelize workloads across multiple cores of GPU(s). Some example runtimes at engine(s) 436 can perform workloads using one or more cores of CPU(s).

In some implementations, engine(s) 436 loaded at an edge system encode images with depth information by performing an ordered pipeline of operations. For example, the ordered pipeline can include a pre-processing portion, an inference portion, and a post-processing portion. Engine(s) 436 can perform the ordered pipeline of operations in sequence for a given batch of images. Some runtimes at engine(s) 436 can parallelize performance of one or more portions of the ordered pipeline, for example for different batches of images, across multiple cores of GPU(s). Some runtimes at engine(s) 436 perform the ordered pipeline in sequence using one or more CPU(s). Examples of engine(s) 436 include versions(s) of Spark AR engine, versions(s) of Spark AR Studio, or any other suitable processing engine for visual frames.

Encoder(s) 438 can encode visual data, such as encoding visual frames provided by camera controller 434, depth augmented visual frames based on a mesh structure, and other suitable visual data. Implementations of encoder(s) 438 encode visual frames such that the frames can be streamed over a real-time communication channel. Encoder(s) 438 can also implement compression techniques to compress the visual frames, for example using known video formats or codecs that compress visual frames. For example, color images can be compressed using standard video compression techniques (e.g., high efficiency video coding (HEVC)). Example encodings include 480p-1080p color images.

In some implementations, encoder(s) 438 encode a video frame with depth information. For example, color pixel values (e.g., RGB values) can be encoded with depth information. An example encoding with depth information includes 16bpp depth images (480p). In some implementations, depth information can be compressed using RVL, RLE, TRVL, or H.264/5 standards.

Decoder(s) 440 can decode encoded visual frames, such as frames encoded by encoder(s) 438. Encoded visual frames can be decoded by decoder(s) 440 to reconstruct the visual frames. In some implementations, decoder(s) 440 can include decompression techniques to reconstruct the visual frames. Implementations of decoder(s) 440 can implement any decompression techniques, decoding algorithms, codecs, and/or conventional video formats that correspond to the compression techniques, encoding algorithms, codecs, and/or conventional video formats implemented by encoder(s) 438.

Workload resource(s) 442 can be resources that configure software (e.g., engine(s) 436) to process visual data. In an example, workload resource(s) 442 can be a trained machine learning model configured to perform a workload on a visual frame, various 2D or 3D models, audio content, kinematic models, mapping or location data (e.g., SLAM data), etc. Example workload resource(s) 442 can be one or more trained machine learning models configured to process visual frames (e.g., stereoscopic frames, signal source frames, etc.) and estimate depth information and/or a mesh structure.

Workload resource(s) 442 can be any other suitable resource (e.g., model, software, etc.) for performing a workload on visual data. Workload resource(s) 442 can be preloaded at edge systems, source systems, and/or target systems such that a workload can be performed on visual frames by an engine (e.g., engine(s) 436) using the preloaded resources. Workload resources 452 can include convolutional neural networks, deep convolutional neural networks, very deep convolutional neural networks, transformer networks, encoders and decoders, generative adversarial networks (GANS), and other suitable machine learning components.

A “machine learning model,” as used herein, refers to a construct that is configured (e.g., trained using training data) to make predictions, provide probabilities, and/or augment data. For example, training data for supervised learning can include items with various parameters and an assigned classification. A new data item can have parameters that a model can use to assign a classification to the new data item. Examples of models include: neural networks, support vector machines, Parzen windows, Bayes, clustering models, reinforcement models, probability distributions, decision trees, decision tree forests, and others. Machine learning models can be configured for various situations, data types, sources, and output formats.

In some implementations, a machine learning model can include one or more neural networks, each with multiple input nodes that receive one or more representations of images. The input nodes can correspond to functions that receive the input and produce results. These results can be provided to one or more levels of intermediate nodes that each produce further results based on a combination of lower level node results. A weighting factor can be applied to the output of each node before the result is passed to the next layer node. At a final layer, (“the output layer”) one or more nodes can produce an output that, once the model is trained, represents a modified version of the input image(s) and/or represents depth information. In some implementations, such neural networks, known as deep neural networks, can have multiple layers of intermediate nodes with different configurations, can be a combination of models that receive different parts of the input and/or input from other parts of the deep neural network, and/or can be a recumbent model (partially using output from previous iterations of applying the model as further input to produce results for the current input).

An example workload resource 442 can be a machine learning model comprising an encoder that converts one or more images (depicting a user) to model input (i.e., an “encoded image”) and a geometry projection branch that can, based on the encoded image, predict a geometry (3D mesh) of the user. In some cases, the machine learning model can also be a recumbent model, using the output of one or more previous iterations in the prediction for a next iteration. Implementations of the machine learning model can also include one or more convolutional layers that process the one or more images.

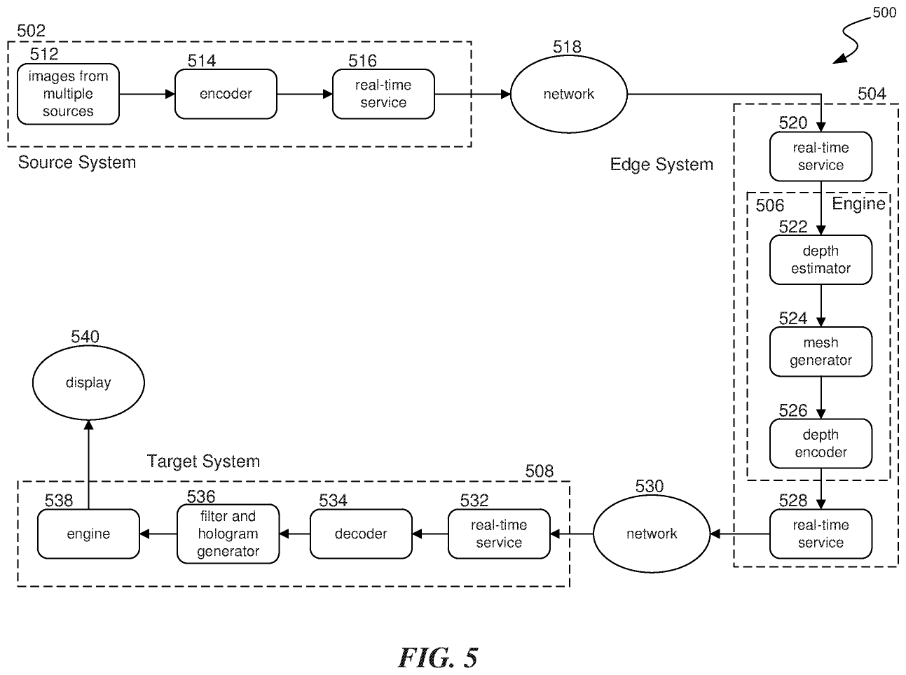

Implementations offload hologram workloads to an edge system, for example when a hologram service (e.g., a hologram call) is triggered between a source system and a target system (e.g., end-user client systems). FIG. 5 is a system diagram illustrating components for encoding images with depth information to support hologram display. System 500 includes source system 502, edge system 504, engine 506, target system 508, images 512, encoder 514, real-time service 516, network 518, real-time service 520, depth estimator 522, mesh generator 524, depth encoder 526, real-time service 528, network 530, real-time service 532, decoder 534, filter and hologram generator 536, engine 538, and display 540.

In the illustrated implementation, a hologram service can be initiated between the source system 502 and the target system 508. Portions of the hologram workload (e.g., a pre-processing, inference, and post-processing ordered pipeline for estimating depth information) can be offloaded to edge system 504. An example flow is illustrated in system 500 that transmits images (e.g., stereoscopic images, single source images, etc.) from source system 502 and displays a hologram at target system 508. Implementations can include a bi-directional flow, such as also transmitting images from target system 508 and displaying a hologram at source system 502, such as a holographic call.

When transmitting images from source system 502 initially, images 512 can be captured by the source system, for example using one camera or multiple cameras that capture the images from multiple perspectives. In some implementations, a separate device (e.g., companion device, XR system, etc.) can capture images 512 and transmit them to source system 502. Images 512 can include a visual representation of a user, such as stereoscopic images of the user, images of the user captured by a single imaging device, or other suitable images.

Images 512 can be provided to encoder 514 for encoding. Encoder 514 can encode the images with any suitable encoding, codec, compression algorithm, known video formats, etc. For example, encoder 514 can generate encoded images suitable for streaming by real-time service 516. Real-time service 516 can implement a real-time communication (RTC) channel. This can be an RTC channel that uses known technologies to facilitate low latency data transfer for holographic services. The RTC channel can correspond to encoders (e.g., encoder 514) and/or decoders (e.g., decoders at client system 504) that implement suitable encoding/decoding algorithms, compression/decompression algorithms, and the like to support real-time communication of visual frames over the RTC channel. The RTC channel can also implement delivery or latency guarantees, security features, routing and transport algorithms, real-time communication protocols, etc. For example, the RTC channel can implement a webRTC session, or any other suitable real-time streaming protocol.

Real-time service 516 can stream the encoded frames over network 518 to edge system 504. For example, network 518 can be any suitable network, such as a heterogenous network that includes wired connection links, wireless connection links, cellular networks, local area networks, the Internet, and any other suitable sub-networks. Implementations of edge system 504 can be proximate to one or more of source system 502 and/or target system 508 such that the supported communication between source system 502 and target system 508 meets a latency criteria (e.g., less than 200 ms, between 100-200 ms, etc.).

In some implementations, proximity to source system 502 is achieved when latency for communication between source system 502 and edge system 504 is between 10-50 ms. The edge system 504 can be at a location that is within a threshold distance (e.g., 1, 5, or 50 miles) from the source system 502, may have a connection capability relative to the source system 502 that meets the latency criteria when a real-time communication session is established, or may otherwise be situated to meet the latency criteria. Edge system 504 can be a network edge device or a personal edge device. For example, a network edge device can be located remote from source system 502 (e.g., off-premises). In addition, a user may own and/or manage source system 502 while an external party (e.g., third-party organization) may manage the network edge device. In some situations, a network edge device can be primarily stationary.

A connection between edge system 504 and source system 502 can also traverse a mixed network. For example, network 518 may include a wireless communication link (e.g., a Wi-Fi communication link and/or a cellular communication link) and a wired communication link (e.g., backhaul communication for a wireless communication network, wired connections that implement a backbone of the Internet, and the like). In some implementations, edge system 504 and source system 502 communicate over a packet switched network that implements Internet Protocol (“IP”).

A personal edge device can be owned and/or managed by the user. For example, source system 502 may include a smart display or a wearable device while the personal edge device can be a laptop or desktop. The personal edge device can connect with source system 502 primarily over a wireless network (e.g., Wi-Fi), via a wireless link (e.g., Bluetooth), or over a network that does not include mixed communication links. In some situations, the personal edge device can be non-stationary.

In some implementations, proximity between edge system 504 and target system 508 can be achieved when a latency criteria is met, distance criteria is met, or otherwise can be similar to the proximity between edge system 504 and client system 502. As opposed to an edge system (e.g., network edge device or personal edge device), a cloud system can be any device that is remote from the client system (e.g., off-premises) whose communications with the client system generally have a latency that is above the latency criteria, such as between 100 and 150 ms.

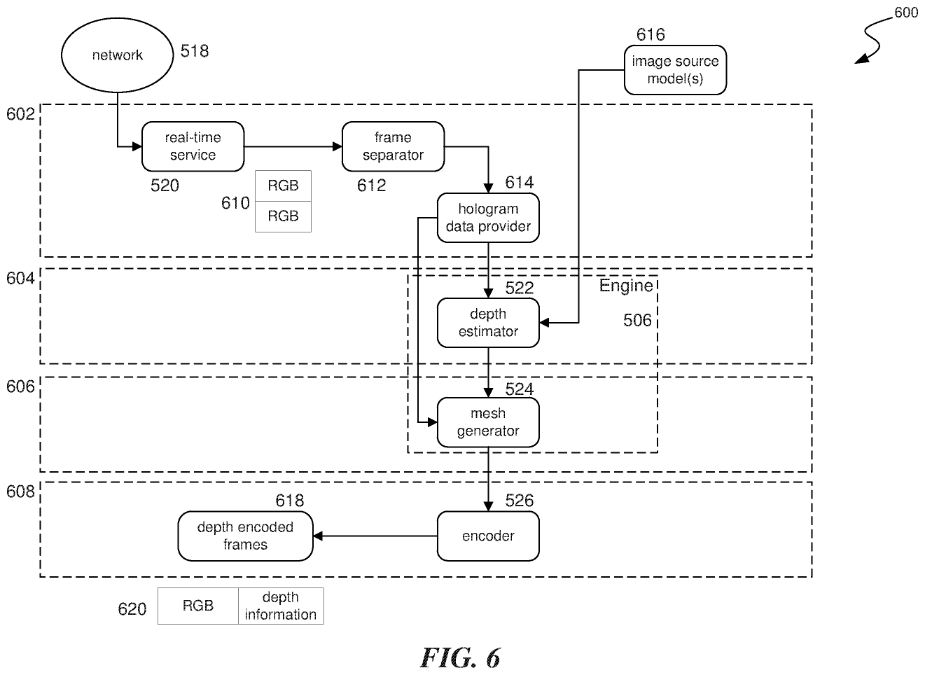

Real-time service 520 can receive the encoded images from real-time service 516 (via network 518) at edge system 504. In some implementations, engine 506 can estimate a depth using the images and generate a mesh structure (representative of a user captured in the images), for example via performance of one or more workloads by depth estimator 522, mesh generator 524, and depth encoder 526. In some implementations, the images capture a user from multiple perspectives (e.g., are stereoscopic images). In another example, the images of the user can be captured from a single imaging device (e.g., from a single perspective). Depth estimator 522 and mesh generator 524 can estimate a mesh structure for the user represented in the images by processing the images using one or more machine learning models. Depth encoder 526 can then generate depth encoded images representative of the mesh structure. System 600 of FIG. 6 provides additional disclosure about engine 504 and encoding the images with depth information.

Real-time service 528 can receive the depth encoded images and stream the images over network 530 to real-time service 532 at target system 508. Real-time service 528 can implement an RTC channel in a manner similar to real-time service 516. Network 530 can be similar to network 518. Once real-time service 532 receives the depth encoded images, they can be provided to decoder 534. Decoder 534 can decode the depth encoded images, for example to generate RGB frames (e.g., pixel values) augmented with depth information. Decoder 534 can provide the decoded images to hologram generator and filter 536. For example, hologram generator and filter 536 can generate the hologram representation of the user using the decoded images augmented with depth information using any suitable known hologram generating/rendering techniques. Conventional techniques for hologram generating/rendering can sometime result in holograms that include noise. Hologram generator and filter 536 can filter the noise to generate a smooth hologram by using any known filtering techniques. The generated (and filtered) hologram can be provided to engine 538. Engine 538 can then display the hologram at display 540. For example, display 540 can be any display suitable for displaying a hologram at target system 508, such as a head-mounted display.

FIG. 6 is a system diagram illustrating components of an edge system for encoding images with depth information to support hologram display. Target system 600 includes decoder element 602, inference element 604, render element 606, encoder element 608, and network 518. Decoder element 602 includes real-time service 520, frame buffer 610, frame separator 612, and hologram data provider 614. Inference element 604 and render element 606 include engine 506, depth estimator 522, and mesh generator 524. Encoder element 608 includes encoder 526, depth encoded frames 618, and depth encoded frame buffer 620.

In some implementations, encoded frames can be received at target system 600 over network 518 at real-time service 520 (as discussed with reference to FIG. 5). Decoder element 602 can decode the encoded frames and generate frame buffer 610 that stores synchronized images of the user. For example, the received images can be captured from different perspectives (e.g., by different cameras) and can include contextual information (e.g., timestamps). Frame buffer 610 can hold two or more images from different perspectives that have been synchronized (e.g., temporally synchronized). In some implementations, the different perspectives of the temporally synchronized images can be used to estimate depth information for the user depicted in the temporally synchronized images. In another example, the received images can be single source/single perspective image(s), and frame buffer 610 can hold the single perspective image(s).

In some implementations, frame separator 612 can separate the frames, such as separate a left frame and a right frame for a pair of temporally synchronized stereoscopic images. In some implementations, the frames are from a single imaging device (e.g., are not stereoscopic). Hologram data provider can generate one or more batches of images to provide to engine 506 and/or one or more machine learning models that estimate the depth represented in the images. For example, depth estimator 522 can comprise one or more machine learning models configured/trained to receive, as input, two-dimensional images and generate a computer generated depth map (CGDM) that estimates depth from the two-dimensional images. Any known machine learning models and/or techniques for estimating depth using two-dimensional images (e.g., stereoscopic images, single perspective images, etc.) can be implemented by depth estimator 522.

In some embodiments, depth estimator 522 can use image source model(s) 616 when estimating the depth information. Image source model(s) 616 can be a model for a stereo RGB camera source, a static dual RGB file on disk that can be streamed to a real-time communication point on server, or any other suitable model. For example, image source model(s) 616 can represent context and/or configurations for the image sources that captured the frames received by edge system 600 (e.g., one or more cameras at the source system). In some implementations, image source model(s) 616 can represent distance(s) (e.g., a distance between cameras, a distance from the target captured, such as the user, etc.) imaging device configurations (e.g., physical characteristics of the imaging devices), and other suitable image source information.

The depth estimation generated by depth estimator 522 and the images can be provided to mesh generator 524 to generate an estimated mesh structure using the images, for example a mesh representation of the user within the images. Mesh generator 524 can comprise one or more machine learning models configured/trained to receive, as input, the estimated depth from depth estimator 522 and the images from hologram data provider 614 as input and generate a mesh structure as output. Any known machine learning models and/or techniques for generating a mesh structure using two-dimensional images and estimated depth can be implemented by mesh generator 524. In some implementations, mesh generator 524 can also generate a texturized layer (e.g., skin) for the generated mesh. For example, one or more machine learning models can be trained/configured to generate the texturized layer for the mesh structure using the estimated depth and images. Any known machine learning models and/or techniques for generating a texturized layer using two-dimensional images and estimated depth can be implemented by mesh generator 524.

Encoder 526 can use the generated mesh structure output by mesh generator 524 to encode two-dimensional images with depth information such that the encoded images are representative of the mesh structure. For example, depth encoded frame buffer 620 can store RGB frames (e.g., RGB pixel values) with augmented depth information. In some implementations, the RGB pixels values and augmented depth information for the depth encoded frames can be representative of the textured layer generated for the mesh structure. Any suitable encoding for two-dimensional frames augmented with depth information can be implemented by encoder 526. The frames can be streamed from frame buffer 620 to a target system using a real-time service.

In some implementations, the functionality of decoder element 602, inference element 604, render element 606, and encoder element 608 can represent an ordered pipeline of operations performed at edge system 600. For example, some or all of the functionality of decoder element 602 can represent a pre-processing component of the pipeline, some or all of the functionality of the inference element 604 and render element 606 can represent an inference portion of the ordered pipeline, and some or all the functionality of encoder element 608 can represent a post-processing portion of the ordered pipeline. This is an exemplary breakdown of the functionality of the ordered pipeline of operations, any other suitable breakdown can be implemented.

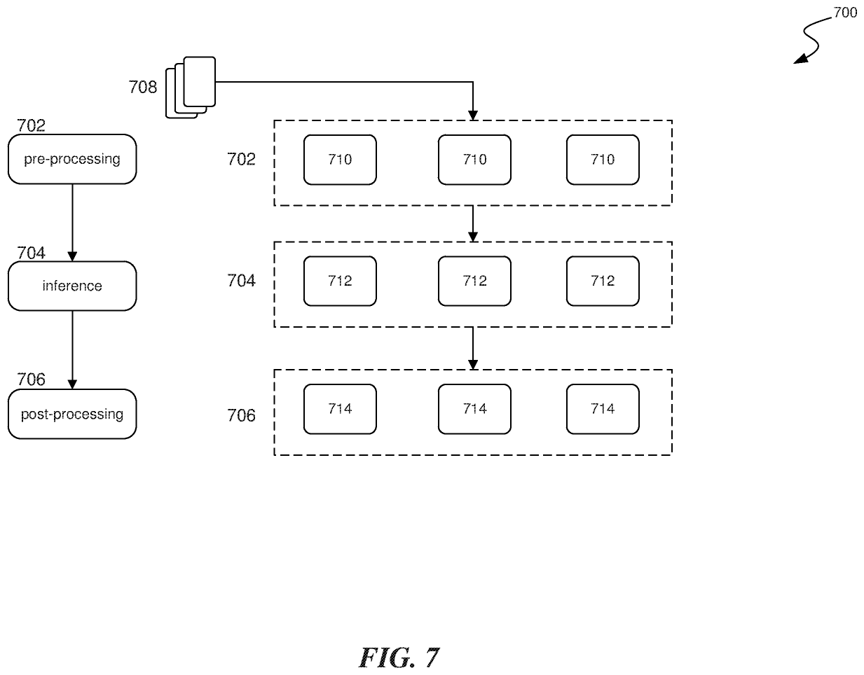

FIG. 7 is a conceptual diagram illustrating an ordered pipeline comprising pre-processing, inference, and post-processing portions. Diagram 700 includes pre-processing portion 702, inference portion 704, post-processing portion 706, batches 708, parallel pre-processing workloads 710, parallel inference workloads 712, and parallel post-processing workloads 714. As described with reference to FIG. 6 and system 600, pre-processing portion 702, inference portion 704, and post-processing portion 706 can receive encoded images, decode the images and pre-process them, perform depth estimation and mesh generation using one or more machine learning models, and encode images with depth information (representative of the mesh structure). For example, batches 708 can represent batches of images for processing by the pipeline of pre-processing portion 702, inference portion 704, and post-processing portion 706.

In some implementations, one or more of the portions of the pipeline can be parallelized across multiple computing elements. For example, parallel pre-processing workloads 710 can represent parallelized pre-processing portions for different batches 708 (e.g., different batches of images). Similarly, parallel inference workloads 712 can represent parallelized inference portions 704 for different batches 708 and parallel post-processing workloads 714 can represent parallelized post-processing portions 706 for different batches 708. In this example, a given batch 708 is processed sequentially through the ordered pipeline (e.g., through processing portion 702, inference portion 704, and post-processing portion 706), however at a given portion of the ordered pipeline different batches 708 can be parallelized. Implementations parallelize portions of the ordered pipeline by performing the workloads across multiple cores of GPU(s).

In some implementations, only a single portion of the ordered pipeline (e.g., pre-processing portion 702, inference portion 704, or post-processing portion 706) can be parallelized. For example, performance of one portion of the ordered pipeline for different batches 708 can be parallelized across multiple cores of a GPU. The other two portions of the ordered pipeline can be performed in sequence and/or executed by one or more cores of a CPU in this example. In some implementations, two of the three portions of the ordered pipeline can be parallelized. For example, performance of two portions of the ordered pipeline for different batches 708 can be parallelized across multiple cores of a GPU. The other portion of the ordered pipeline can be performed in sequence and/or executed by one or more cores of a CPU in this example.

In some implementations, parallelization of one or more portions of the ordered pipeline can be based on the engines loaded/detected at an edge system. For example, a first engine can support ordered pipeline execution in sequence in combination with multi-core GPU execution of individual portions of the ordered pipeline while a second engine can support ordered pipeline execution in an ordered sequence in combination with CPU execution of the ordered pipeline. Implementations of the first engine can include a runtime environment that supports multi-core GPU hardware (e.g., CUDA runtime) while implementations of the second engine can include a runtime environment that supports CPU hardware. The first engine can include both a runtime environment that supports multi-core GPU hardware and a runtime environment that supports CPU hardware in some implementations. Parallelizing individual components of the ordered pipeline can increase processing speed and ultimately reduce latency for communication between the source system and the target system via the edge system such that a performed hologram service can be supported.

In some implementations, parallelized workloads (e.g., one or more of parallel pre-processing workloads 710, parallel inference workloads 712, and parallel post-processing workloads 714) are performed by multiple instances of running engine(s) or runtime environment(s). For example, a configuration file (e.g., manifest) at the edge system can define multiple running instances of engine(s) and/or runtime environment(s). In another example, multiple running instances of engine(s) and/or runtime environment(s) can be detected (e.g., by a script file that interrogates the edge system). One or more workloads can be parallelized across the running engine(s) and/or runtime environment(s) to achieve the parallel execution of workloads.

In some implementations, sequential performance of the ordered pipeline of operations (e.g., for a given batch of images) is achieved by a predefined sequence of services that correspond to the portions of the ordered pipeline. For example, each portion of the ordered pipeline can correspond to a service defined at the edge system (e.g., pre-processing service, inference service, post-processing service). For a given batch of images, running instance(s) of engine(s)/runtime environment(s) can be configured to perform the services corresponding to the ordered pipeline in the defined order. In some implementations, the sequence for the services can be predefined at the edge system or the sequence can be received in a configuration file. For example, a manifest file (or any other suitable configuration file) at the edge system can predefine the sequence for the pre-processing service, inference service, and post-processing service for any image(s) received in association with edge hologram services. In this example, the ordered sequence will be enforced by the manifest file stored at the edge system.

In another example, a configuration file can be received in association with the hologram edge service (e.g., from the source system, a third-party system, or any other suitable system). In this example, the configuration file received at the edge system can predefine the sequence for the pre-processing service, inference service, and post-processing service for any image(s) received in association with edge hologram services. Accordingly, the ordered sequence will be enforced by the configuration file received at the edge system.

In some implementations, sequential performance of the ordered pipeline of operations is achieved by a blocking mechanism and running engine(s) or runtime environment(s). For example, a manifest file, configuration file, or any other suitable file can configure the scheduling of services at multiple running engine(s) or runtime environment(s) at the edge system. The manifest file or configuration file can define a blocking mechanism that blocks scheduling/execution of later portions of the ordered pipeline (later corresponding services at the edge system) for a given batch of images until execution of earlier portions of the ordered pipeline (earlier corresponding services at the edge system) for the given batch of images. For example, the blocking mechanism can ensure that a running instance of an engine/runtime environment is blocked from executing the inference service or post-processing service of the ordered pipeline for the given batch of images until execution of the pre-processing service for the given batch of images.

Those skilled in the art will appreciate that the components illustrated in FIGS. 1-7 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

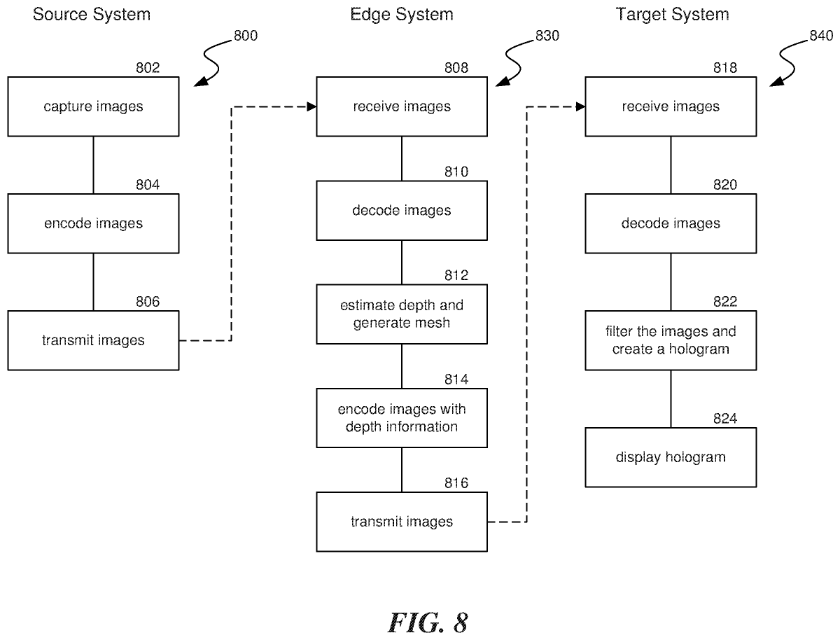

FIG. 8 is a flow diagram illustrating a processes 800, 830, and 840 used in some implementations of the present technology for encoding images with depth information to support hologram display. In some implementations, processes 800, 830, and 840 can be triggered by a holographic service, such as initiation of a holographic call or any other suitable service that performs hologram rendering. Blocks 802, 804, and 806 of process 800 can be implemented at a source system, blocks 808, 810, 812, 814, and 816 of process 830 can be implemented at an edge system, and blocks 818, 820, 822, 824 of process 840 can be implemented at a target system.

At block 802, process 800 can capture images. For example, a source system can capture images using multiple cameras from multiple perspectives. In some implementations the source system can be an XR system (or any other suitable system) with image capturing device(s) that can capture images of a user from multiple perspectives. Example captured images can be two-dimensional stereoscopic frames, any other suitable two-dimensional images that capture a user from multiple perspectives, single perspective/single source images, or any other suitable images.

At block 804, process 800 can encode the captured images. For example, the source system can include an encoder that can generate encoded frames suitable for communication over a RTC channel. In some implementations, the encoder can compress the frames or perform any other known encoding techniques for visual data.

At block 806, process 800 can transmit the encoded images over a RTC channel. For example, the source system can stream the encoded frames over a network to an edge system. The RTC channel can implement a webRTC session, or any other suitable real-time streaming protocol.

At block 808, process 830 can receive the encoded images. For example, the encoded images can be received at an edge system. At block 810, process 830 can decode the encoded images. For example, the edge system can include a decoder that decodes the encoded images. In some implementations, the decoder at the edge system can correspond to the encoder at the source system such that the encoding/compression performed at the source system can be decoded/decompressed at the edge system.

At block 812, process 830 can estimate depth data for the decoded images. In some cases, this depth data can also be used to generate a mesh of the depicted user. For example, the edge system can buffer the images for processing (e.g., temporally synchronize images from different perspectives, buffer single perspective images, etc.), estimate depth from the images (e.g., estimate a CGDM), and generate a mesh structure using the estimated depth data. One or more machine learning models can be trained/configured to estimate depth for the images. For example, such a model can be trained using images taken simultaneously with a depth camera and 2D camera, where the image from the 2D camera is provided to the model and the output of the model is compared to the depth camera image and, based on the comparison, the model parameters are updated. As another example, such a model can be trained using synthetic images taken from a VR environment where depth data is known for images taken with a virtual camera—which can similarly then be used to train the model with the image from the virtual 2D camera provided to the model and the output of the model is compared to the depth data and, based on the comparison, the model parameters are updated. In various implementations, the depth data can be procedurally used to generate the mesh structure and/or a trained machine learning model can be used to take depth data and produce a mesh. In some implementations, the generated mesh structure represents a mesh of a user included in the decoded images. In some implementations, the generated mesh includes a texturized layer (e.g., skin) that supports hologram display. Any other suitable techniques can be implemented to estimate depth and generate a mesh using the decoded images.

At block 814, process 830 can encode images with depth information representative of the mesh structure. For example, the edge system can augment color values (e.g., RGB pixel values) with depth information to encode the images with the depth information. Any other suitable technique to encode two-dimensional images with depth information can be implemented.

In some implementations, sequential performance of blocks 810-814 is achieved by a predefined sequence of services that correspond to the portions of an ordered pipeline. For example, each portion of the ordered pipeline can correspond to a service defined at the edge system (e.g., pre-processing service, inference service, post-processing service). An instance process 800 can perform the services corresponding to the ordered pipeline in the defined order. In some implementations, the sequence for the services can be predefined at the edge system or the sequence can be received in a configuration file. For example, a manifest file (or any other suitable configuration file) at the edge system can predefine the sequence for the pre-processing service, inference service, and post-processing service for any image(s) received in association with edge hologram services. For example, a manifest defined for hologram processing can enforce a pipeline order, on the edge server, in which a depth estimation model is performed firs, output from the depth estimation model (i.e., images with depth data) is provided to a mesh creation module, and the mesh provided by the mesh creation module is provided to an encoder. In another example, a configuration file can be received in association with the hologram edge service (e.g., from the source system, a third-party system, or any other suitable system). In this example, the configuration file received at the edge system can predefine the sequence for the pre-processing service, inference service, and post-processing service for any image(s) received in association with edge hologram services.

At block 816, process 830 can transmit the depth encoded images. For example, the edge system can transmit the depth encoded images to a target system over a RTC channel that traverses a network.

At block 818, process 840 can receive the depth encoded images. For example, the target system can receive the depth encoded images from the edge system. At block 820, process 840 can decode the depth encoded images. For example, a decoder at the target system can correspond to an encoder at the edge system such that that the encoding/compression performed at the edge system can be decoded/decompressed at the target system.

At block 822, process 840 can generate a hologram and perform filtering using the decoded depth augmented images. For example, a hologram representation of the user can be generated using the decoded images augmented with depth information based on any suitable known hologram generating/rendering techniques. Conventional techniques for hologram generating/rendering can sometime result in holograms that include noise. The generated hologram can be filtered to smooth the noise using any known filtering techniques.

At block 824, process 840 can display the hologram. For example, the target system can display the hologram using any suitable display technique. In some implementations, the target system can be an XR system with a HMD, and the hologram can be displayed using the XR system. The target system can be any other suitable system capable of displaying a hologram. Additional details on depth estimation, model generation, encoding/decoding, rendering, and display are provided in U.S. patent application Ser. No. 17/360,693, titled Holographic Calling for Artificial Reality, filed Jun. 28, 2021, which is herein incorporated by reference in its entirety.

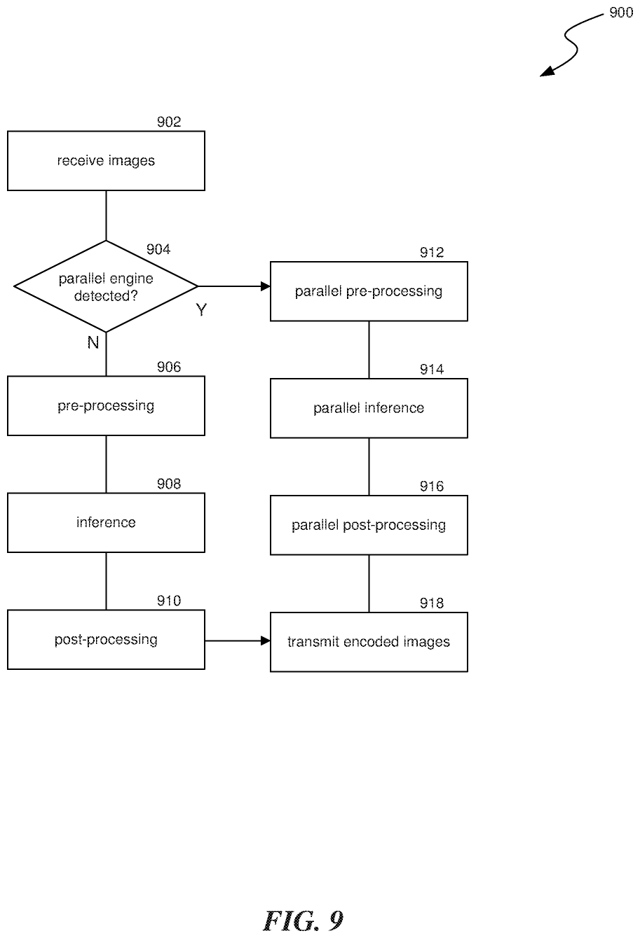

In some implementations, the edge system can process images of the user received at the edge system (from the source system) using an ordered pipeline of operations. For example, workload(s) related to hologram processing/rendering can be offloaded from the source system/target system to the edge system, and the edge system can parallelize execution of portions of these workload(s), for example across multiple cores of a GPU. FIG. 9 is a flow diagram illustrating a process used in some implementations of the present technology for perform pre-processing, inference, and post-processing on received images. In some implementations, process 900 can be triggered by a holographic service, such as initiation of a holographic call or any other suitable service that performs hologram rendering. The performance of process 900 can achieve functionality of process 840 of FIG. 8. For example, process 900 can be performed at an edge system that receives encoded images, estimates a depth and generates a mesh using the images, and generates depth encoded images that support hologram display.

At block 902, process 900 receives encoded images. For example, the encoded images can be received from a source system. In some implementations, the encoded images can be two-dimensional stereoscopic frames encoded by an encoder at the source system, any other suitable two-dimensional images that capture a user from multiple perspectives encoded by the encoder, single perspective/single source images encoded by the encoder, or any other suitable encoded images.

At block 904, process 900 determines whether an engine that supports parallel execution is detected. For example, a first engine can support ordered pipeline execution in sequence in combination with parallelized multi-core GPU execution of individual portions of the ordered pipeline. A second engine can support ordered pipeline execution in an ordered sequence in combination with CPU execution of the ordered pipeline. Implementations of the first engine can include a runtime environment that supports multi-core GPU hardware (e.g., CUDA runtime) while implementations of the second engine can include a runtime environment that supports CPU hardware (or GPU hardware without parallelization). The first engine can include both a runtime environment that supports multi-core GPU hardware with parallelization and a runtime environment that supports CPU hardware in some implementations.

Detection of an engine (or runtime) loaded at the edge system that supports parallelization for at least a portion of an ordered pipeline of operations can be achieved by: detection of an engine/runtime identifier (e.g., listed on a manifest file) associated with multi-core GPU parallelization (e.g., predefined association between the engine identifier and parallelization capabilities); interrogation of the engine (e.g., by one or more scripts) to detect a runtime associated with multi-core GPU parallelization (e.g., CUDA runtime, etc.); any combination of these; or by any other suitable techniques. When an engine that supports parallel execution is detected, process 900 progresses to block 912. When an engine that does not support parallel execution is detected, process 900 progresses to block 906.

At blocks 906, 908, and 910, process 900 performs a pre-processing portion, inference portion, and post-processing portion of the ordered pipeline. For example, the ordered pipeline of operations can include: receiving encoded images, decoding the images and pre-processing them, performing depth estimation and mesh generation using one or more machine learning models, and generating depth encoded images representative of the mesh. Blocks 906, 908, and 910 perform the ordered pipeline in sequence and without parallelization across multiple cores of a GPU. For example, when process 900 progresses to blocks 906, 908, and 910, an engine/runtime that supports parallelization across multiple cores of a GPU was not detected at the edge system. Accordingly, the ordered pipeline of operations can be performed in sequence without GPU multi-core parallelization.

When, at block 904, the parallel engine is detected, one or more of the portions of the ordered pipeline can be parallelized. At blocks 912, 914, and 916, process 900 performs parallel execution of one or more of a pre-processing portion, inference portion, and post-processing portion of the ordered pipeline. For example, the ordered pipeline of operations can include: receiving batches of encoded images, decoding the batches of images and pre-processing them, performing depth estimation and mesh generation using one or more machine learning models, and generating depth encoded images representative of the mesh. When process 900 progresses to blocks 912, 914, and 916, an engine/runtime that supports parallelization across multiple cores of a GPU was detected at the edge system. Accordingly, execution of one or more of the pre-processing portion, inference portion, and/or post-processing portion can be parallelized across multiple cores of implemented GPU(s) at the edge system. For example, one or more of the portions of the ordered pipeline can be parallelized across multiple cores of a GPU for different batches of images.

In some implementations, only a single portion of the ordered pipeline (e.g., pre-processing, inference, or post-processing) is parallelized. For example, performance of one portion of the ordered pipeline for different batches of images can be parallelized across multiple cores of GPU(s). The other two portions of the ordered pipeline can be performed in sequence and/or executed by one or more cores of a CPU in this example. In some implementations, two of the three portions of the ordered pipeline can be parallelized. For example, performance of two portions of the ordered pipeline for different batches of images can be parallelized across multiple cores of GPU(s). The other portion of the ordered pipeline can be performed in sequence and/or executed by one or more cores of a CPU in this example. In some implementations, the three portions of the ordered pipeline can be parallelized across multiple cores of GPU(s) for different batches of images.

At block 918, process 900 transmits depth encoded images to a target system. For example, performance of the ordered pipeline of operations (e.g., via blocks 906, 908, 910 and/or blocks 912, 914, and 916) can generate a mesh structure that represents a three-dimensional version of a user. In some implementations the edge system can include an encoder that augments color values (e.g., RGB pixel values) with depth information to generate depth encoded images representative of the mesh stucture. The encoded images can then be streamed from the edge system to a target system (via a RTC channel that traverses a network), where the target system is configured to display a hologram of the user based on the depth encoded images.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/we claim:

1. A method for encoding images with depth information at an edge system to support hologram display, the method comprising:
receiving, at an edge system from a source system, images of a user over a real-time communication (RTC) channel, wherein latency for the communication over the RTC channel between the edge system and the source system is between 10 ms and 50 ms, and wherein the images are: a) captured at the source system using a plurality of cameras; and b) encoded at the source system prior to transmission to the edge system;
processing, at the edge system, the received images using an ordered pipeline to estimate depth information for the images and generate depth encoded images, wherein the ordered pipeline comprise a pre-processing portion, an inference portion, and post-processing portion; and
transmitting, from the edge system to a target system, the depth encoded images over a real-time communication channel, wherein the depth encoded images are used at the target system to displayed a hologram of the user.

2. The method of claim 1, wherein the processing the received images using the ordered pipeline generates a 3D mesh structure and the depth encoded images are representative of the 3D mesh structure.

3. The method of claim 1, wherein the generating the depth encoded images comprises augmenting color pixel values with the depth information.

4. The method of claim 1, wherein additional images are received from the target system that comprise an other user, additional depth encoded images are generated at the edge system using the additional images, and the additional depth encoded images are transmitted to the source system such that the additional depth encoded images are displayed at the source system as a hologram of the other user.

5. The method of claim 4, wherein the hologram displays of the user and the other user comprise a holographic call.

6. The method of claim 1, wherein a latency for the communication between the source system and the target system via the edge system that supports the display of the hologram of the user is less than 200 ms.

7. The method of claim 1, further comprising:
detecting one or more processing engines at the edge system, wherein, when a first processing engine is detected the edge system performs the ordered pipeline in sequence and parallelizes at least one portion of the ordered pipeline across multiple cores of one or more graphics processing units (GPUs); and
when a second processing engine is detected the edge system performs the ordered pipeline in sequence using one or more central processing units (CPUs).

8. The method of claim 7, wherein, when the first processing engine is detected, the inference portion of the ordered pipeline is parallelized across multiple cores of one or more GPUs, wherein performing the inference portion comprises using one or more machine learning models that perform the estimation of the depth information.

9. The method of claim 1, wherein the edge system performs the ordered pipeline portions in sequence and parallelizes at least one portion of the ordered pipeline across multiple cores of one or more GPUs.

10. A computer-readable storage medium storing instructions that, when executed by a computing system, cause the computing system to perform a process for encoding images with depth information at an edge system to support hologram display, the process comprising:
receiving, at an edge system from a source system, one or more images of a user over a real-time communication (RTC) channel, wherein latency for the communication over the RTC channel between the edge system and the source system is between 10 ms and 50 ms, and wherein the one or more images are: a) captured at the source system using one or more cameras; and b) encoded at the source system prior to transmission to the edge system;
processing, at the edge system, the received one or more images using an ordered pipeline to estimate depth information for the one or more images and generate one or more depth encoded images, wherein the ordered pipeline comprise a pre-processing portion, an inference portion, and post-processing portion; and
transmitting, from the edge system to a target system, the one or more depth encoded images over a real-time communication channel, wherein the one or more depth encoded images are used at the target system to displayed a hologram of the user.

11. The computer-readable storage medium of claim 10, wherein the processing the received one or more images using the ordered pipeline generates a 3D mesh structure and the one or more depth encoded images are representative of the 3D mesh structure.

12. The computer-readable storage medium of claim 10, wherein the generating the one or more depth encoded images comprises augmenting color pixel values with the depth information.

13. The computer-readable storage medium of claim 10, wherein additional images are received from the target system that comprise an other user, additional depth encoded images are generated at the edge system using the additional images, and the additional depth encoded images are transmitted to the source system such that the additional depth encoded images are displayed at the source system as a hologram of the other user.

14. The computer-readable storage medium of claim 13, wherein the hologram displays of the user and the other user comprise a holographic call.

15. The computer-readable storage medium of claim 10, wherein a latency for the communication between the source system and the target system via the edge system that supports the display of the hologram of the user is between 100 ms and 200 ms.

16. The computer-readable storage medium of claim 10, wherein the process further comprises:
detecting one or more processing engines at the edge system, wherein,
when a first processing engine is detected the edge system performs the ordered pipeline in sequence and parallelizes at least one portion of the ordered pipeline across multiple cores of one or more graphics processing units (GPUs); and
when a second processing engine is detected the edge system performs the ordered pipeline in sequence using one or more central processing units (CPUs).

17. The computer-readable storage medium of claim 16, wherein, when the first processing engine is detected, the inference portion of the ordered pipeline is parallelized across multiple cores of one or more GPUs, wherein performing the inference portion comprises using one or more machine learning models to generate a 3D mesh representation of the user.

18. The computer-readable storage medium of claim 10, wherein the edge system performs the ordered pipeline portions in sequence and parallelizes at least one portion of the ordered pipeline across multiple cores of one or more GPUs.

19. An edge computing system for encoding images with depth information to support hologram display, the edge computing system comprising:
one or more processors; and
one or more memories storing instructions that, when executed by the one or more processors, cause the edge computing system to perform a process comprising:
receiving, at an edge system from a source system, one or more images of a user over a real-time communication (RTC) channel, wherein latency for the communication over the RTC channel between the edge system and the source system is between 10 ms and 50 ms, and wherein the one or more images are: a) captured at the source system using one or more cameras; and b) encoded at the source system prior to transmission to the edge system;
processing, at the edge system, the received one or more images using an ordered pipeline to estimate depth information for the one or more images and generate one or more depth encoded images, wherein the ordered pipeline comprise a pre-processing portion, an inference portion, and post-processing portion; and
transmitting, from the edge system to a target system, the one or more depth encoded images over a real-time communication channel, wherein the one or more depth encoded images are used at the target system to displayed a hologram of the user.

20. The system of claim 19, wherein the processing the received one or more images using the ordered pipeline generates a 3D mesh structure and the one or more depth encoded images are representative of the 3D mesh structure.
